(19) United States
(12) Patent Application Publication
(10) Pub. No.: US 2026/0317173 A1
(43) Pub. Date: Oct. 15, 2026

(54) ELECTRICALLY INSULATING AND THERMALLY CONDUCTIVE PARTICLE, ELECTRICALLY INSULATING AND THERMALLY CONDUCTIVE POLYMER CONTAINING THE SAME, AND METHOD FOR PREPARING THE ELECTRICALLY INSULATING AND THERMALLY CONDUCTIVE PARTICLE

(71) Applicant: INDUSTRIAL TECHNOLOGY RESEARCH INSTITUTE, Hsinchu (TW)

(72) Inventors: Dong-Sen Chen, Zhudong Township (TW); Jheng-Ying Li, Taoyuan City (TW); Yu-Ju Kuo, Zhubei City (TW); Pei-Ying Liu, Zhudong Township (TW); Chun-Wei Su, Zhubei City (TW)

(73) Assignee: INDUSTRIAL TECHNOLOGY RESEARCH INSTITUTE, Hsinchu (TW)

(21) Appl. No.: 19/645,750

(22) Filed: Apr. 13, 2026

(30) Foreign Application Priority Data
Apr. 11, 2025 (TW) 114113891

(51) Int. Cl. C01B 21/064; C08K 3/38

(52) U.S. Cl. CPC C01B 21/0648; C08K 3/38; C01P 2006/12; C01P 2006/32; C01P 2006/40; C08K 2003/385; C08K 2201/005; C08K 2201/006; C08K 2201/011

(57) ABSTRACT

An electrically insulating and thermally conductive particle includes cross-linked modified boron nitride. The cross-linked modified boron nitride includes a reaction product of a boron nitride particle, a coupling agent, and a cross-linking agent, where the boron nitride particle accounts for at least 92 wt % of a total weight of the cross-linked modified boron nitride. The electrically insulating and thermally conductive particle has an average particle size of 1800 to 4200 nm and a particle size corresponding to 90% of a cumulative total amount (D90) of less than 6000 nm. A density of the electrically insulating and thermally conductive particle ranges from 2.8 g/cm³ to 3.5 g/cm³.

### CROSS-REFERENCE TO RELATED APPLICATION

This non-provisional application claims priority under 35 U.S.C. § 119(a) to patent application No. 114113891 filed in Taiwan, R.O.C. on Apr. 11, 2025, the entire contents of which are hereby incorporated by reference.

### TECHNICAL FIELD

The present disclosure relates to the field of thermal conduction, and in particular to an electrically insulating and thermally conductive particle, an electrically insulating and thermally conductive polymer containing the same, and a method for preparing the electrically insulating and thermally conductive particle.

### BACKGROUND

With the development of various electronic components, the increase in high-frequency applications and computing capabilities has been accompanied by a rise in the thermal energy generated. At the same time, the trend toward lighter, thinner, shorter, and smaller electronic devices results in reduced internal space and higher component density, which makes the problem of overheating failure of electronic components more likely. Therefore, the issue of heat dissipation has received more attention.

Nowadays, the casings of electronic components or the molding materials for special packaging often possess enhanced thermal conductivity by adding thermally conductive particles. Metal particles are commonly used, but they can easily cause issues such as electromagnetic shielding or short circuits. Alternatively ceramic thermally conductive particles can be used, however, their proportion in the mixture is limited-too much can make the molding material difficult to form, while too little yields only limited improvement in thermal performance.

### SUMMARY

Provided herein is an electrically insulating and thermally conductive particle. The electrically insulating and thermally conductive particle includes cross-linked modified boron nitride. The cross-linked modified boron nitride includes a reaction product of a boron nitride particle, a coupling agent, and a cross-linking agent, wherein an amount of the boron nitride particle is at least 92 wt %, based on a total weight of the cross-linked modified boron nitride. The coupling agent is selected from the group consisting of an oxysilane coupling agent, a titanate coupling agent, an isocyanate coupling agent, and a phosphate coupling agent. The cross-linking agent is selected from the group consisting of aromatic and aliphatic compounds containing two or more reactive functional groups, and the reactive functional groups include carboxy groups, anhydride groups, amine groups, hydroxy groups, or isocyanate groups. An average particle size of the electrically insulating and thermally conductive particle is 1800 to 4200 nm, and a particle size corresponding to 90% of a cumulative total amount (D90) is less than 6000 nm.

Further provided herein is an electrically insulating and thermally conductive polymer, including the aforementioned electrically insulating and thermally conductive particles and a polymer material as a matrix. The electrically insulating and thermally conductive particles are dispersed in the polymer material and account for 70 to 90 wt % of a total weight of the electrically insulating and thermally conductive polymer, and a thermal conductivity coefficient of the electrically insulating and thermally conductive polymer is greater than 2.25 W/m·K.

In some embodiments, a method for preparing the above-mentioned electrically insulating and thermally conductive particle is further provided. The method for preparing an electrically insulating and thermally conductive particle includes a delamination step, a modification step, a cross-linking step, and a pulverization step. The delamination step includes adding boron nitride particles and a first solvent into a reaction flask, and performing ultrasonic vibration for at least three hours to obtain a plurality of delaminated boron nitride particles. The modification step includes adding a coupling agent into the reaction flask and heating and refluxing with the delaminated boron nitride particles for a reaction to obtain a plurality of modified boron nitride particles. A weight ratio of the coupling agent to the boron nitride particles is 0.01 to 0.1, and the coupling agent is selected from the group consisting of an oxysilane coupling agent, a titanate coupling agent, an isocyanate coupling agent, and a phosphate coupling agent.

The cross-linking step includes adding the modified boron nitride particles, a second solvent, and a cross-linking agent into the reaction flask for mixing, and heating and refluxing to obtain cross-linked modified boron nitride particles, where a weight ratio of the cross-linking agent to the modified boron nitride particles is 0.03 to 0.08. The cross-linking agent is selected from the group consisting of aromatic and aliphatic compounds containing two or more reactive functional groups, and the reactive functional groups include carboxy groups, anhydride groups, amine groups, hydroxy groups, or isocyanate groups. The pulverization step includes taking out the cross-linked modified boron nitride particles, drying the particles, and then pulverizing them to obtain a plurality of electrically insulating and thermally conductive particles with an average particle size of 1800 to 4200 nm. The particle size corresponding to 90% of a cumulative total amount (D90) of the electrically insulating and thermally conductive particles is less than 6000 nm.

### BRIEF DESCRIPTION OF THE DRAWINGS

FIG. 1 is a flow chart of a method for preparing an electrically insulating and thermally conductive particle.

### DETAILED DESCRIPTION

Exemplary embodiments will be described in detail below with reference to the drawings to facilitate implementation by those of ordinary skill in the art. The overall concept of the present disclosure may be embodied in various forms and is not limited to the set exemplary embodiments.

In addition, the terms “first”, “second”, and “third” are only used to distinguish one element, component, region, layer, or portion from another element, component, region, layer, or portion, and do not indicate a necessary order thereof.

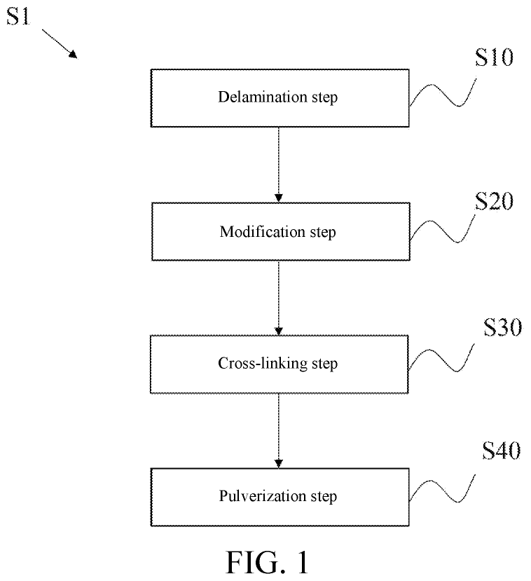

FIG. 1 is a flow chart of a method for preparing an electrically insulating and thermally conductive particle. As shown in FIG. 1, a method S1 for preparing an electrically insulating and thermally conductive particle is provided herein. The method S1 for preparing an electrically insulating and thermally conductive particle includes a delamination step S10, a modification step S20, a cross-linking step S30, and a pulverization step S40.

The delamination step S10 includes adding boron nitride particles and a first solvent into a reaction flask, followed by vibrating the mixture in an ultrasonic vibration tank for some time, such as three hours or longer, to generate delaminated boron nitride particles. Van der Waals forces between layers in boron nitride are disrupted through vibration, and this change can be inferred from an increase in the average particle size of the boron nitride particles. Herein, the boron nitride may adopt different crystalline forms such as hexagonal crystalline boron nitride (α-BN), cubic crystalline boron nitride (β-BN), zinc blende crystalline boron nitride, or wurtzite crystalline boron nitride.

The modification step S20 includes adding a coupling agent into the reaction flask and heating to induce reflux between the coupling agent and the delaminated boron nitride particles, thereby modifying a surface of the delaminated boron nitride particles to obtain a plurality of modified boron nitride particles. A weight ratio of the coupling agent to the boron nitride particles may be 0.01 to 0.1, for example, 0.01 to 0.08, 0.01 to 0.05, 0.02 to 0.08, or 0.03 to 0.06. The coupling agent contains a modifying functional group selected from the group consisting of a siloxane group, a titanate group, an isocyanate group, and a phosphate group. After the modification step S20, the modified boron nitride particles are more swollen than the delaminated boron nitride particles, such that the particle size increases.

In some embodiments, the modification step is carried out by heating and refluxing at above 60 degrees Celsius for at least 1.5 hours. However, this is merely an example and not intended to be limiting.

In more detail, in some embodiments, the coupling agent may be an oxysilane coupling agent, a titanate coupling agent, an isocyanate coupling agent, a phosphate coupling agent, or a combination thereof. For example, the coupling agent may be 3-aminopropyltriethoxysilane (APTES), γ-3-aminopropyltriethoxysilane (γAPTES), γ-3-methacryloxypropyltrimethoxysilane, γ-3-aminopropyltrimethoxysilane, vinyltriethoxysilane, (3-glycidyloxypropyl)trimethoxysilane (GPTMS), tetra-isopropyl titanate, tetra-butyl titanate, toluene diisocyanate (TDI), methylenediphenyl diisocyanate (MDI), ethoxy phosphate, or a combination thereof.

The cross-linking step S30 includes mixing the plurality of modified boron nitride particles, a second solvent, and a cross-linking agent to allow the cross-linking agent and the modified boron nitride particles to undergo a cross-linking reaction, and heating (e.g., above 80° C.) and refluxing (e.g., for more than 1.5 hours) to obtain cross-linked modified boron nitride particles, where the cross-linked modified boron nitride particles may be in the form of relatively large lumps. A weight ratio of the cross-linking agent to the modified boron nitride particles may be 0.03 to 0.08, for example, 0.03 to 0.07. The cross-linking agent may be selected from the group consisting of aromatic and aliphatic compounds containing two or more reactive functional groups. The reactive functional groups include carboxy groups, anhydride groups, amine groups, hydroxy groups, or isocyanate groups. The pulverization step S40 includes taking out the cross-linked modified boron nitride particles, drying the particles, and then performing pulverization to obtain electrically insulating and thermally conductive particles.

In some embodiments, the first solvent does not react with the coupling agent. For example, in some embodiments, the first solvent may be water, alcohol, isopropanol, acetone, isopropyl ketone, or a combination thereof. The second solvent may be toluene or ethylbenzene.

In more detail, in some embodiments, the cross-linking agent may be N-(oxiranylmethyl)-N-phenyl-oxiranemethanamine, 1,3-propanediol, 2,3,4-trimethyl-1,3-pentanediol, 2-butene-1,4-diol, 1,4-butanediol, 1,3-butanediol, 1,5-pentanediol, 1,6-hexanediol, 1,2-cyclohexanedimethanol, 1,2-hexanediol, 1,3-hexanediol, 2-methyl-1,3-propanediol, 2,5-hexanediol, 2-methyl-1,3-pentanediol, 2-methyl-2,4-pentanediol, ethylene glycol, diethylene glycol, triethylene glycol, tetraethylene glycol, polyethylene glycol, propylene glycol, dipropylene glycol, polypropylene glycol, tripropylene glycol, glycerol, polyglycerol, ethylene carbonate, 1,2-propylene carbonate, or a combination thereof.

The electrically insulating and thermally conductive particles can be obtained via the above preparation method. The electrically insulating and thermally conductive particles include cross-linked modified boron nitride. The cross-linked modified boron nitride includes a reaction product of boron nitride, a coupling agent, and a cross-linking agent, where boron nitride accounts for at least 92 wt % of a total weight of the cross-linked modified boron nitride. The coupling agent is selected from the group consisting of an oxysilane coupling agent, a titanate coupling agent, an isocyanate coupling agent, and a phosphate coupling agent; and the cross-linking agent is selected from the group consisting of aromatic and aliphatic compounds containing two or more reactive functional groups, where the reactive functional groups include carboxy groups, anhydride groups, amine groups, hydroxy groups, or isocyanate groups.

According to embodiments of the present disclosure, through density tests of the electrically insulating and thermally conductive particles disclosed by the present disclosure, a density of the electrically insulating and thermally conductive particles ranges from 2.8 g/cm³ to 3.5 g/cm³.

Through particle size analysis, the electrically insulating and thermally conductive particles have an average particle size of 1800 to 4200 nm, and a particle size corresponding to 90% of a cumulative total amount (D90) is less than 6000 nm. In some embodiments, the average particle size of the electrically insulating and thermally conductive particles is 3750 nm. In some embodiments, a particle size corresponding to 10% of the cumulative total amount (D10) of the electrically insulating and thermally conductive particles is less than 1750 nm, and a particle size corresponding to 50% of the cumulative total amount (D50) of the electrically insulating and thermally conductive particles is less than 2500 nm.

In some embodiments, a specific surface area of the electrically insulating and thermally conductive particles ranges from 2 to 25 m²/g.

Further, the electrically insulating and thermally conductive polymer may be obtained by mixing the electrically insulating and thermally conductive particles into a polymer material. In more detail, the electrically insulating and thermally conductive polymer includes the aforementioned electrically insulating and thermally conductive particles and a polymer material. The electrically insulating and thermally conductive particles are dispersed in the polymer material and account for 50 to 90 wt % (e.g., 70 to 90 wt %, or 70 to 80 wt %) of a total weight of the electrically insulating and thermally conductive polymer, and a thermal conductivity coefficient of the electrically insulating and thermally conductive polymer is greater than 2.25 W/m·K.

In some embodiments, the polymer material is selected from the group consisting of polydimethylsiloxane (PDMS), thermoplastic polyurethane (TPU), butyl rubber (IIR), ethylene propylene diene monomer rubber (EPDM), styrene-butadiene rubber (SBR), acrylic rubber (ACM), and a fluoroelastomer (FKM).

In some embodiments, a density of the electrically insulating and thermally conductive polymer is between 2.75 and 3.25 g/cm³.

In some embodiments, a thermal diffusion coefficient of the electrically insulating and thermally conductive polymer is greater than 0.95 mm²/s.

In some embodiments, a specific heat capacity of the electrically insulating and thermally conductive polymer is between 0.78 and 1.10 J/g·K.

To make the above content and other objectives, features, and advantages of the present disclosure clearer and more comprehensible, preferred examples are specifically described in detail below in conjunction with the accompanying drawings.

### Preparation of Electrically Insulating and Thermally Conductive Particles

### EXAMPLE 1

First, 15 g of hexagonal boron nitride particles and 3 kg of a 50% isopropyl alcohol (IPA) aqueous solution were placed in a reaction flask, which was then placed in an ultrasonic tank to vibrate for 6 hours to perform the delamination step S10 to obtain delaminated boron nitride.

Next, (3-glycidyloxypropyl)trimethoxysilane (GPTMS) was added to modify the surface of the delaminated boron nitride, where the weight ratio of GPTMS to boron nitride was 0.045:1.5. The mixture was heated and refluxed for two hours to perform the modification step S20. After filtration and drying, modified boron nitride particles were obtained.

Subsequently, 1.5 g of the filtered and dried modified boron nitride particles were taken and mixed with 0.05 g of N-(oxiranylmethyl)-N-phenyl-oxiranemethanamine, and the mixture was added to 100 g of toluene to perform the cross-linking step S30. The mixture was heated and refluxed for about two hours. Finally, after filtration and drying, cross-linked modified boron nitride particles were obtained, which were then pulverized with a pulverizer at a speed of 12000 rpm to obtain electrically insulating and thermally conductive particles (I).

A particle size analyzer (model: nanoSAQLA+AS50, Otsuka Electronics) was used to analyze the particle size of the boron nitride particles obtained at each stage in Example 1. The results are shown in Table 1 below.

TABLE 1

| | Average | Average | | | |
|---|---|---|---|---|---|
| | particle | particle | | | |
| | size (nm) | size (nm) | | | |
| | (Cumulative | (Histogram | D10 | D50 | D90 |
| | calculation) | distribution) | (nm) | (nm) | (nm) |
| Hexagonal boron | 500 | 550 | 275 | 325 | 475 |
| nitride particles | | | | | |
| Delaminated boron | 700 | 700 | 350 | 850 | 850 |
| nitride particles | | | | | |
| Modified boron | 950 | 950 | 550 | 750 | 1000 |
| nitride particles | | | | | |
| Electrically insulating | 3000 | 3750 | 1750 | 2500 | 6000 |
| and thermally | | | | | |
| conductive particles (I) | | | | | |

It can be understood that the overall particle size of hexagonal boron nitride particles becomes larger through delamination, modification, and cross-linking treatments. This can be verified by the increase in the particle size of boron nitride particles at each stage, as shown in Table 1. Hexagonal boron nitride particles account for at least 92 wt % (weight percentage) of the overall cross-linked modified boron nitride, and the remaining portion consists of reaction residuals between the coupling agent or the cross-linking agent and the boron nitride raw materials, among other things. In addition, the overall density decreases due to the increase in the particle size of boron nitride molecules.

### EXAMPLE 2

Example 2 was carried out in accordance with the steps and conditions described in Example 1, except that 1.5 g of the filtered and dried modified boron nitride particles were taken and mixed with 0.1 g of N-(oxiranylmethyl)-N-phenyl-oxiranemethanamine for a reaction. Electrically insulating and thermally conductive particles (II) were obtained.

### EXAMPLE 3

The above delaminated boron nitride was taken and modified using 3-aminopropyltriethoxysilane (APTES) as the coupling agent, where the weight ratio of APTES to boron nitride was 0.045:1.5. The mixture was heated and refluxed at 80° C. for two hours to perform the modification step S20. After filtration and drying, modified boron nitride particles were obtained.

Subsequently, 1.5 g of the filtered and dried modified boron nitride particles were taken and mixed with 0.05 g of N-(oxiranylmethyl)-N-phenyl-oxiranemethanamine, and the mixture was added to 100 g of toluene to perform the cross-linking step S30. The mixture was heated and refluxed at 80° C. for about two hours. Finally, the cross-linked modified boron nitride particles obtained after filtration and drying were pulverized with a pulverizer at a speed of 12000 rpm to obtain electrically insulating and thermally conductive particles (III).

### EXAMPLE 4

Example 4 was carried out in accordance with the steps and conditions described in Example 3, except that 1.5 g of the filtered and dried modified boron nitride particles were taken and mixed with 0.1 g of N-(oxiranylmethyl)-N-phenyl-oxiranemethanamine for a reaction. Electrically insulating and thermally conductive particles (IV) were obtained.

### Preparation of Electrically Insulating and Thermally Conductive Polymers

### EXAMPLE 5-EXAMPLE 10

The above electrically insulating and thermally conductive particles (I)-(IV) were compounded into a polydimethylsiloxane (PDMS, purchased from Shin-Etsu Silicone Photonics) polymer material at different doping ratios. The proportion of PDMS was adjusted according to the particle filling ratio (as shown in Table 2 below) to prepare electrically insulating and thermally conductive polymers (1)-(6).

### COMPARATIVE EXAMPLE 1-COMPARATIVE EXAMPLE 6

The boron nitride particles in Comparative Examples 1 and 2 used the modified boron nitride particles from Examples 1 and 3 (reacted with GPTMS and APTES coupling agents, respectively) but without undergoing cross-linking, i.e., uncross-linked modified hexagonal boron nitride particles. Comparative Example 3 used boron nitride particles that were undelaminated, unmodified, and uncross-linked; the S-boron nitride (S—BN) in Comparative Examples 4 and 5 was prepared by only delaminating hexagonal boron nitride particles, but without subsequent modification and cross-linking. Comparative Example 6 was prepared by compounding the electrically insulating and thermally conductive particles of the present disclosure into PDMS, but the particle filling ratio was only 60%.

The test results of relevant properties of various electrically insulating and thermally conductive particles are shown in Table 2. The density was measured using a PX223ZH densitometer from Ohaus. First, the density of the liquid (heptane) was set, then the weight of the sample in air was measured, followed by its weight in the liquid, and the density of the sample was calculated therefrom. The thermal diffusion coefficient was measured using an LFA 447 Laser Flash analyser from NETZSCH. First, the thickness of the sample was measured and its dimensions were confirmed; then, graphite was uniformly sprayed on the test sample; and finally, the instrument measurement parameters were set before measurement was performed, and the thermal diffusion coefficient could be obtained through software calculation. The specific heat capacity was measured using a DSC 250 Differential Scanning calorimeter from TA Instruments. First, the sample was weighed and placed in a platinum pan for tableting; then, the DSC heating conditions (20° C./min) were set and the test was performed; 3 sets of data were measured for the empty pan, the standard sample (sapphire), and the test sample, and finally the specific heat capacity was obtained through software calculation. The thermal conductivity coefficient was obtained through calculation. The calculation formula for thermal conductivity coefficient was K (W/m·K)=α (mm²/s)×ρ (g/cm³)×Cp (J/g·K), where α was the thermal diffusion coefficient; ρ was the density; and Cp was the specific heat capacity.

TABLE 2

| | | | Weight of | | | | | | |
|---|---|---|---|---|---|---|---|---|---|
| | | | electrically | | Electrically | | | | |
| | Electrically | | insulating | | insulating | | | | |
| | insulating and | Particle | and | Weight | and | | Thermal | Specific | Thermal |
| | thermally | filling | thermally | of | thermally | | diffusion | heat | conductivity |
| | conductive | ratio | conductive | PDMS | conductive | Density | coefficient | capacity | coefficient |
| | particles | (%) | particles (g) | (g) | polymer | (g/cm³) | (mm²/s) | (J/g · K) | (W/m · K) |
| Example 5 | (I) | 75 | 7.5 | 2.5 | (1) | 3.013 | 0.957 | 0.798 | 2.30 |
| Example 6 | (II) | 75 | 7.5 | 2.5 | (2) | 2.897 | 0.954 | 0.886 | 2.45 |
| Example 7 | (II) | 80 | 8.0 | 2.0 | (3) | 2.974 | 0.984 | 1.096 | 3.21 |
| Example 8 | (III) | 75 | 7.5 | 2.5 | (4) | 2.825 | 1.036 | 0.803 | 2.35 |
| Example 9 | (IV) | 75 | 7.5 | 2.5 | (5) | 2.904 | 0.962 | 0.956 | 2.67 |
| Example 10 | (IV) | 80 | 8.0 | 2.0 | (6) | 3.021 | 1.127 | 1.096 | 3.45 |
| Comparative | Uncross-linked | 75 | 7.5 | 2.5 | (7) | 2.893 | 0.905* | 0.802 | 2.10* |
| Example 1 | modified BN | | | | | | | | |
| | particles | | | | | | | | |
| Comparative | Uncross-linked | 75 | 7.5 | 2.5 | (8) | 2.833 | 0.943* | 0.805 | 2.15* |
| Example 2 | modified BN | | | | | | | | |
| | particles | | | | | | | | |
| Comparative | Undelaminated/ | 75 | 7.5 | 2.5 | (9) | 2.526 | 0.953 | 0.831 | 2.00* |
| Example 3 | uncross-linked/ | | | | | | | | |
| | unmodified BN | | | | | | | | |
| | particles | | | | | | | | |
| Comparative | S-BN particles | 75 | 7.5 | 2.5 | (10) | 2.531 | 0.957 | 0.879 | 2.13* |
| Example 4 | | | | | | | | | |
| Comparative | S-BN particles | 80 | 8.0 | 2.0 | (11) | 2.534 | Film cracked/unable to form film, | | |
| Example 5 | | | | | | | making measurement impossible | | |
| Comparative | (I) | 60 | 6.0 | 4.0 | (12) | 2.857 | 0.957 | 0.794 | 2.17* |
| Example 6 | | | | | | | | | |

Herein, the particle filling ratio refers to the weight percentage of the electrically insulating and thermally conductive particles in the electrically insulating and thermally conductive polymer [electrically insulating and thermally conductive particles/(electrically insulating and thermally conductive particles+polymer material)×100%]. In addition, the electrically insulating and thermally conductive polymer is considered to meet application requirements only when its thermal performance exceeds relevant specifications, such as with a thermal conductivity coefficient greater than 2.25 W/m·K, a thermal diffusion coefficient greater than 0.95 mm²/s, and/or a specific heat capacity between 0.78 and 1.10 J/g·K. None of the Comparative Examples 1-6 meet the thermal conductivity requirements (indicated by * in Table 2). Furthermore, regarding the material formulation, if the particle filling ratio of the comparative examples is increased to slightly beyond 75%, for example, raised to between 78% and 80%, the electrically insulating and thermally conductive polymer is unable to form a film (e.g., Comparative Example 5). Therefore, it is impossible to achieve the required thermal conductivity effect by adding more thermally conductive particles.

In summary, the electrically insulating and thermally conductive particles prepared by delaminating, modifying, and cross-linking boron nitride particles can increase the interlayer spacing of boron nitride (this can be inferred from the increase in the average particle size of boron nitride particles at each stage shown in Table 1). This makes the electrically insulating and thermally conductive particles easier to bond with the polymer material and improves their compatibility. Furthermore, it enables the weight ratio of the electrically insulating and thermally conductive particles added to the polymer matrix to reach 75% or beyond (e.g., 80%), thereby effectively enhancing the thermal conductivity effect of the thermally conductive polymer, improving the thermal conduction property, and making it more suitable for electronic devices of high-frequency and/or high-power applications.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. An electrically insulating and thermally conductive particle, comprising:
cross-linked modified boron nitride, comprising a reaction product of a boron nitride particle, a coupling agent, and a cross-linking agent, wherein an amount of the boron nitride particle is at least 92 wt %, based on a total weight of the cross-linked modified boron nitride,
wherein the coupling agent is selected from the group consisting of an oxysilane coupling agent, a titanate coupling agent, an isocyanate coupling agent, and a phosphate coupling agent;
wherein the cross-linking agent is selected from the group consisting of aromatic and aliphatic compounds containing two or more reactive functional groups, and the reactive functional groups comprise carboxy groups, anhydride groups, amine groups, hydroxy groups, or isocyanate groups; and
wherein an average particle size of the electrically insulating and thermally conductive particle is 1800 to 4200 nm, and a particle size corresponding to 90% of a cumulative total amount (D90) of the electrically insulating and thermally conductive particle is less than 6000 nm.

2. The electrically insulating and thermally conductive particle according to claim 1, wherein the average particle size of the electrically insulating and thermally conductive particle is 3500 to 4000 nm.

3. The electrically insulating and thermally conductive particle according to claim 1, wherein a particle size corresponding to 10% of the cumulative total amount (D10) of the electrically insulating and thermally conductive particle is less than 1750 nm, and a particle size corresponding to 50% of the cumulative total amount (D50) of the electrically insulating and thermally conductive particle is less than 2500 nm.

4. The electrically insulating and thermally conductive particle according to claim 1, wherein the electrically insulating and thermally conductive particle has a specific surface area of 2 to 25 m²/g and a density of 2.8 g/cm³ to 3.5 g/cm³.

5. An electrically insulating and thermally conductive polymer, comprising:
a plurality of the electrically insulating and thermally conductive particles according to claim 1, wherein an amount of the electrically insulating and thermally conductive particles is 70 to 90 wt %, based on a total weight of the electrically insulating and thermally conductive polymer; and
a polymer material, wherein the electrically insulating and thermally conductive particles are dispersed in the polymer material;
wherein a thermal conductivity coefficient of the electrically insulating and thermally conductive polymer is greater than 2.25 W/m·K.

6. The electrically insulating and thermally conductive polymer according to claim 5, wherein the polymer material is selected from the group consisting of polydimethylsiloxane, thermoplastic polyurethane, butyl rubber, ethylene propylene diene monomer rubber, styrene-butadiene rubber, acrylic rubber, and a fluoroelastomer.

7. The electrically insulating and thermally conductive polymer according to claim 5, wherein the electrically insulating and thermally conductive polymer has a density of 2.75 to 3.25 g/cm³.

8. The electrically insulating and thermally conductive polymer according to claim 5, wherein the electrically insulating and thermally conductive polymer has a thermal diffusion coefficient greater than 0.95 mm²/s.

9. The electrically insulating and thermally conductive polymer according to claim 5, wherein the electrically insulating and thermally conductive polymer has a specific heat capacity of 0.78 to 1.10 J/g·K.

10. The electrically insulating and thermally conductive polymer according to claim 5, wherein the amount of the electrically insulating and thermally conductive particles is 70 to 80 wt %, based on the total weight of the electrically insulating and thermally conductive polymer.

11. A method for preparing an electrically insulating and thermally conductive particle of claim 1, comprising:
a delamination step: adding a plurality of boron nitride particles and a first solvent into a reactor, and performing ultrasonic vibration to obtain a plurality of delaminated boron nitride particles;
a modification step: adding a coupling agent into the reactor, and heating and refluxing with the delaminated boron nitride particles to obtain a plurality of modified boron nitride particles, wherein a weight ratio of the coupling agent to the boron nitride particles is 0.01 to 0.1, and wherein the coupling agent is selected from the group consisting of an oxysilane coupling agent, a titanate coupling agent, an isocyanate coupling agent, and a phosphate coupling agent;
a cross-linking step: mixing the modified boron nitride particles, a second solvent, and a cross-linking agent, and heating and refluxing to obtain cross-linked modified boron nitride particles, wherein a weight ratio of the cross-linking agent to the modified boron nitride particles is 0.03 to 0.08, and wherein the cross-linking agent is selected from the group consisting of aromatic and aliphatic compounds containing two or more reactive functional groups, and the reactive functional groups comprise carboxy groups, anhydride groups, amine groups, hydroxy groups, or isocyanate groups; and
a pulverization step: drying the cross-linked modified boron nitride particles, and then performing pulverization to obtain a plurality of electrically insulating and thermally conductive particles with an average particle size of 1800 to 4200 nm and a particle size corresponding to 90% of a cumulative total amount (D90) of less than 6000 nm.

12. The method for preparing an electrically insulating and thermally conductive particle according to claim 11, wherein a particle size corresponding to 10% of the cumulative total amount (D10) of the electrically insulating and thermally conductive particles is less than 1750 nm, and a particle size corresponding to 50% of the cumulative total amount (D50) of the electrically insulating and thermally conductive particles is less than 2500 nm.

13. The method for preparing an electrically insulating and thermally conductive particle according to claim 11, wherein the first solvent does not react with the coupling agent, and the second solvent is toluene or ethylbenzene.
